(19) United States
(12) Patent Application Publication
(10) Pub. No.: US 2026/0170160 A1
(43) Pub. Date: Jun. 18, 2026

(54) Secure Group-Based Data Sharing Between Applications

(71) Applicant: Citrix Systems, Inc., Fort Lauderdale, FL (US)

(72) Inventors: Vikram Vitthalrao Bhagwat, Bangalore (IN); Zaid Sajid Merchant, Bangalore (IN); Siddheshwar Kamatar, Bangalore (IN); Santosh Sampath Gummunur Chiranjeevi, Bangalore (IN); Devendra Satram, Tirupati (IN)

(21) Appl. No.: 18/983,758

(22) Filed: Dec. 17, 2024

(51) Int. Cl. G06F 21/62; H04L 9/08

(52) U.S. Cl. CPC G06F 21/6209; H04L 9/0819; G06F 2221/2141

(57) ABSTRACT

Systems and methods described herein enable the sharing of encrypted data files based on data sharing rules. A data sharing rule may include multiple groups of applications. Applications that are members of a given group are allowed to access encrypted data files downloaded or created by other member applications of the group, while requests by non-member applications to access the encrypted data files are rejected.

### FIELD

Aspects described herein generally relate to sharing data amongst applications in user devices. Additional aspects described herein relate to allowing the sharing of encrypted data between applications belonging to a group and rejecting requests for access to the encrypted data from applications that are not members of the group.

### BACKGROUND

Due to increases in remote work and the use of mobile devices, an organization may need a comprehensive strategy for its members to have secure “anytime, anywhere” access to the organization's corporate resources. Such corporate resources may include legacy systems, applications, proprietary data, non-proprietary data, etc. Organization members may access corporate resources using various types of user devices, such as corporate-issued devices, unmanaged personal devices, devices connected to the organizations'networks, devices physically present in the organization's campuses, devices present outside the campuses, etc. One of the main concerns of an organization may be preventing the misuse of data through user devices, which can result in identity thefts and/or data breaches. Especially, organizations are concerned about the misuse of proprietary data through unmanaged personal devices.

One way to prevent misuse may be to prohibit the downloading of all types of data on non-corporate issued devices or devices present outside of the organization's campus. However, such a measure may prevent organization members from having “anytime, anywhere” access to corporate resources, e.g. the ability to access corporate resources at any time from any location outside of the corporate campus or buildings. Another way to prevent misuse may be to encrypt all data (e.g., proprietary data and non-proprietary data) accessed by user devices, such as downloaded files, created files, cookies, cache, and/or browsing history. While such across-the-board encryption may protect against data breaches and/or unauthorized access to proprietary data, it may also negatively impact user experience for the organization members. Furthermore, such across-the-board encryption may still result in data breaches. For example, an encrypted file downloaded by a web application running within a browser (e.g., a file downloaded from a sensitive internal web application) may be later accessed by other web applications running within the browser (e.g., the downloaded file may be uploaded to a web application for personal emails opened from within the browser).

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards systems and methods that provide increased granularity of encryption of data accessed by user devices instead of across-the-board encryption.

In one or more examples, the method or methods described herein may comprise a computing device receiving a data sharing rule where the data sharing rule indicates at least one group of applications that are authorized to share data. Applications that do not belong to the same group of applications may not be authorized to share data. The computing device may receive an encrypted file for a first application. The computing device may then receive, from a second application, a first request to access the content of the encrypted file, and the computing device may decrypt, based on the first application and the second application being included in the at least one group of applications, the encrypted file for the second application. The computing device may receive, from a third application, a second request to access the content of the encrypted file, and the computing device may reject, based on the third application not being included in the group of applications, the second request to access the content of the encrypted file.

In some examples, the data sharing rule may be based on a user identifier of a user of the computing device, a device identifier of the computing device, or a store identifier of an application store providing the first application.

In some examples, receiving the encrypted file by the computing device may comprise downloading a non-encrypted file by the first application, receiving an application key associated with the first application, generating a content key associated with the encrypted file, generating the encrypted file by encrypting the non-encrypted file with the content key, generating metadata for the encrypted file, encrypting the metadata with the application key, and adding the encrypted metadata to the encrypted file. The computing device may generate the metadata based on one or more of: a user identifier of a user of the computing device, a device identifier of the computing device, a store identifier of an application store, an application identifier for the first application, or the content key.

In some examples, decrypting the encrypted file for the second application by the computing device may further comprise decrypting the encrypted metadata with the application key, retrieving the content key, and decrypting the encrypted file with the content key.

In some examples, the applications in the group of applications share a clipboard, and the computing device may allow each application, in the group of applications, access to content in the clipboard and deny another application, not included in the group of applications, access to the content in the clipboard.

In some examples, decrypting the encrypted file for the second application by the computing device may comprise sending, to a key management server, information comprising one or more of: a user identifier of a user accessing the encrypted file, a device identifier of the computing device, an application identifier of the first application, a file location of the encrypted file in the computing device, or a store identifier for an application store providing the first application. The computing device may receive, from the key management server, a key and decrypt at least a portion of the encrypted file with the key. In some examples, the computing device may send the information to the key management server based on a determination that the key is not stored in a cache of the computing device.

In some embodiments, the computing device may decrypt the encrypted file for the second application by decrypting at least a portion of the encrypted file with a key associated with the first application.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative computing environment where applications in user devices share data based on data sharing rules in accordance with one or more illustrative aspects described herein.

FIG. 6 depicts an illustrative data sharing rule in accordance with one or more illustrative aspects described herein.

FIGS. 7A, 7B, 7C, 7D, 7E, and 7F depict illustrative event sequences for providing a user device with a data sharing rule and managing data sharing between applications in the user device based on the data sharing rule in accordance with one or more illustrative aspects described herein.

FIGS. 8A, 8B, and 8C depict an illustrative method for data sharing between applications in a user device in accordance with one or more illustrative aspects described herein.

FIG. 9 depicts an illustrative method for providing data sharing rules in accordance with one or more illustrative aspects described herein.

FIG. 10 depicts an illustrative method for providing application keys in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards encryption and/or decryption policies of data files accessed by applications in user devices. Instead of encrypting all data files, aspects described herein may provide encryption and/or decryption policies that are based on memberships of the applications to user-specified and/or organization-specified groups of applications. Any encrypted data downloaded or created by a member application of a group may be decrypted for, shared by, or accessed by other member applications in the same group such that the other member applications may also access the content of the encrypted files. However, in at least some circumstances, the encrypted data will not be decrypted for applications that do not belong to the group. Such encryption and/or decryption policies may be enforced on a user device via a data sharing rule that may be unique for the user device and/or the user of the user device. Each data sharing rule for a certain user device and/or a certain user may comprise policies for multiple groups of applications present e in that user device.

A data file may be encrypted by a single application key that is specific to a user device, a user, and/or an application downloading or creating the data file. The single application key may be a symmetric key that may be further used to decrypt the data file. A key management server may generate the application key for the data file. The key management server may generate the application key. The application key may be unique to the application that downloaded or created the data file, the user and the user device downloading the file, and/or the application store from which the application is available. Alternatively, a key management server may generate a pair of keys comprising a public key and a private key for the data file. The public key may be used to encrypt data, and the private key may be used to decrypt data. The public-private pair of keys may also be unique to the application that downloaded the file, the user downloading the file, the user device downloading the file, and/or the application store from which the application is available. Although examples described herein use symmetric application keys, those of skill in the art would understand that the public-private pair of application keys may also be used.

In some examples, multiple keys may be used for encrypting and decrypting different portions of a data file. For example, a user device may receive an application key from the key management server, where the application key is unique to the user device, the user of the user device, and/or the application that downloaded or created the data file. The user device may generate a content key. Both the application key and the content key may be symmetric keys. Alternately, the application key or the content key may comprise a public-private pair of keys.

The non-encrypted version of the data file may include content and metadata that provides descriptive information about the content. The content portion of the non-encrypted data file may be encrypted with the application key received from the key management server, while the metadata may be encrypted with the application key. During the decryption process, the content portion of the non-encrypted data file may be decrypted with the application key received from the key management server, and the metadata may be decrypted with the application key. In some examples, the content key may be included in the metadata, and the decryption process may involve decrypting the metadata portion of the data file with the application key first to retrieve the content key and then decrypting the content portion of the data file with the retrieved content key.

A group of applications in a data sharing rule may comprise only local applications, only remote applications, or a mix of local and remote applications. Local applications may be installed in user devices and/or be executed or launched locally by user devices. Remote applications are executed or launched on other devices and accessed by a user by a browser presented on the user device. Remote applications may be variously referred to as web applications, network applications, or software-as-a-service (SaaS) applications. In some examples, a remote application may correspond to a local application, such as a webmail client may correspond to a local email client, or a SaaS word processing application may correspond to a local word processing application. Organizations may prefer that users utilize remote applications, which may provide enhanced security, policy control, reliability, and additional features such as real-time collaboration, version journaling, or other such features. However, for various reasons, users may sometimes instead launch local applications rather than the corresponding remote applications.

As an example, a group of applications may comprise remote applications Google Sheets®, Google Docs®, and Workday®, and a local Microsoft Excel® application. For this example, an encrypted document downloaded from Google Sheets may only be accessed by Google Docs or Workday running within a browser and may also be opened by the native Microsoft Excel application. No other applications will be able to open the document. As a result, a user will not be able to upload this document in a decrypted manner to Gmail® running in a browser or the native Microsoft Outlook® application. Additionally, the document may continue to be encrypted after being edited with either Google Sheets, Google Docs, Workday, or the native Microsoft Excel application.

In the systems described herein, the network administrators of organizations may tailor different data sharing rules for different users (e.g., C-suite executives, managers, non-managers, employees at the human recourses department, etc.) and/or different types of user devices (e.g., corporate-issued or personal user devices, devices present with an organization's premises, devices outside the organization's premises), providing the organizations with more granularity in terms of securing certain types of data only for certain users and/or certain user devices. The systems described herein may provide improved security by using a unique application key for each application in a user device and prevent unauthorized data sharing between applications.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### COMPUTING ARCHITECTURE

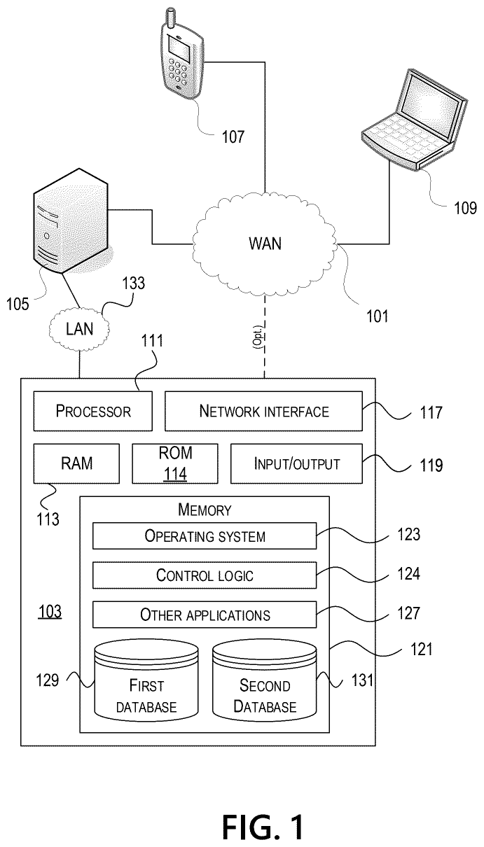

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—that resides across all physical networks.

The components may include data server 103, web server 105, and user devices 107, 109. Data server 103 provides overall access, control and administration of databases and control software for performing one or more illustrative aspects described herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed websites hosted by web server 105. User devices 107, 109 may be used in concert with data server 103 to access data stored therein, or may be used for other purposes. For example, from user device 107, a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling the overall operation of the data server 103. Data server 103 may further include random access memory (RAM) 113, read-only memory (ROM) 114, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling the overall operation of the data processing device 103, control logic 124 for instructing data server 103 to perform aspects described herein, and other application software 127 providing secondary, support, and/or other functionality which may or might not be used in conjunction with aspects described herein. The control logic 124 may also be referred to herein as the data server software 125. Functionality of the data server software 125 may refer to operations or decisions made automatically based on rules coded into the control logic 124, made manually by a user providing input into the system, and/or a combination of automatic processing based on user input (e.g., queries, data updates, etc.).

Memory 121 may also store data used in the performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid-state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

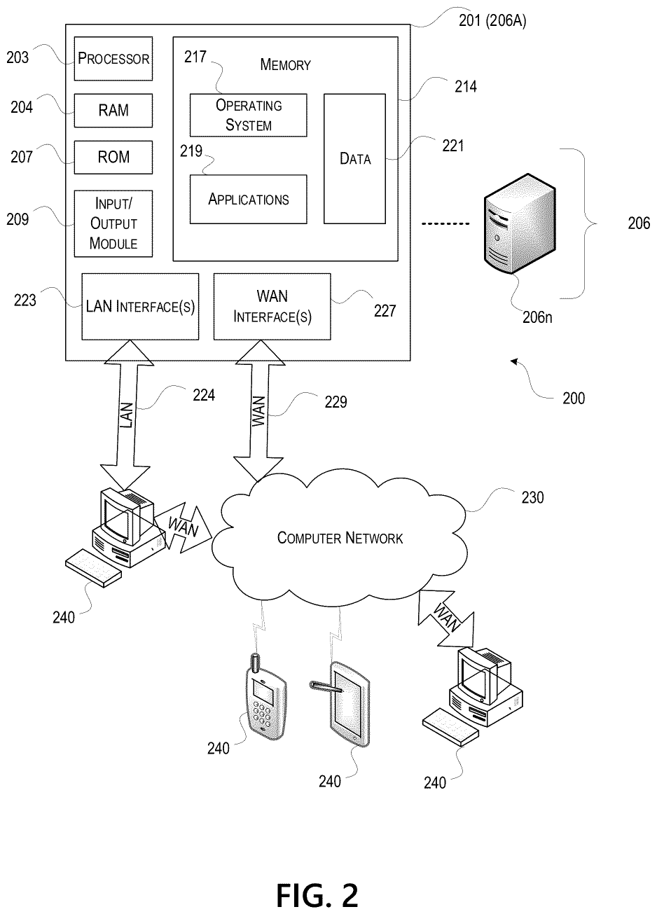

With further reference to FIG. 2, one or more aspects described herein may be implemented in a remote-access environment. FIG. 2 depicts an example system architecture, including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling the overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special-purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as user devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative, and other means of establishing a communications link between the computers may be used. Computing device 201 and/or terminals 240 may also be mobile terminals (e.g., mobile phones, smartphones, personal digital assistants (PDAs), notebooks, etc.), including various other components, such as a battery, speaker, and antennas (not shown).

Aspects described herein may also be operational with numerous other general purpose or special-purpose computing system environments or configurations. Examples of other computing systems, environments, and/or configurations that may be suitable for use with aspects described herein include but are not limited to, personal computers, server computers, hand-held or laptop devices, multiprocessor systems, microprocessor-based systems, set-top boxes, programmable consumer electronics, network personal computers (PCs), minicomputers, mainframe computers, distributed computing environments that include any of the above systems or devices, and the like.

As shown in FIG. 2, one or more user devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and, in some cases, can load balance client connections amongst a plurality of backend servers 206.

The client machine(s) 240 may, in some embodiments, be referred to as a single client machine 240 or a single group of client machines 240, while server(s) 206 may be referred to as a single server 206 or a single group of servers 206. In one embodiment, a single client machine 240 communicates with more than one server 206, while in another embodiment, a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); user device(s); user device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments, the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects, the virtual machine may be managed by a hypervisor executing on a server 206 or a hypervisor executing on a user device 240.

Some embodiments include a user device 240 that displays application output generated by an application remotely executing on a server 206 or other remotely located machine. In these embodiments, the user device 240 may execute a virtual machine receiver program or application to display the output in an application window, a browser, or other output window. In one example, the application is a desktop, while in other examples, the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments, the server farm 206 may be administered as a single entity, while in other embodiments, the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

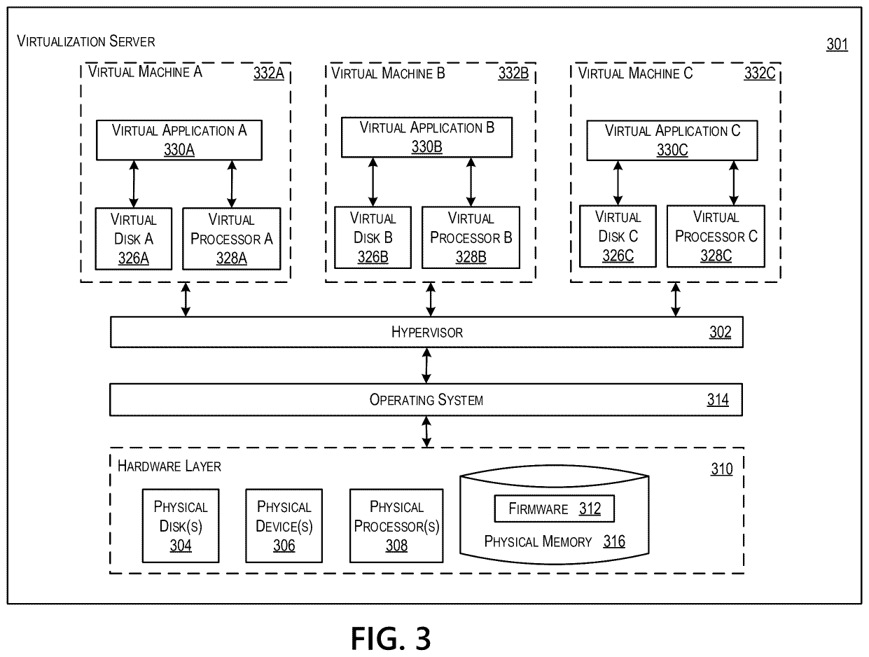

FIG. 3 depicts an illustrative virtualization server 301 (e.g., the virtualization servers 324) that may be used in accordance with one or more illustrative aspects described herein. As shown, the virtualization server 301 may be a single-server or multi-server system or cloud system, configured to provide virtual applications to one or more on-premise user devices (e.g., on-premise user device 304) and/or one or more remote user devices (e.g., remote user device 306). Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

Virtualization server 301 illustrated in FIG. 3 can be deployed as and/or implemented by one or more embodiments of the server 206 illustrated in FIG. 2, the virtualization servers 326 in FIG. 3, or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, one or more virtual machines 332B-C can execute, using a virtual processor 328B-C, virtual applications 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and/or one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments, may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to virtual applications 330 executing on virtual machines 332 in any manner that simulates the virtual applications 330 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which virtual applications 330 execute. In some embodiments, hypervisor 302 may load a virtual machine image to create a virtual machine 332. In other embodiments, the hypervisor 302 may execute a virtual application 330 within virtual machine 332. In other embodiments, virtual machine 332 may execute virtual application 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments, the virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, the application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, may be a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

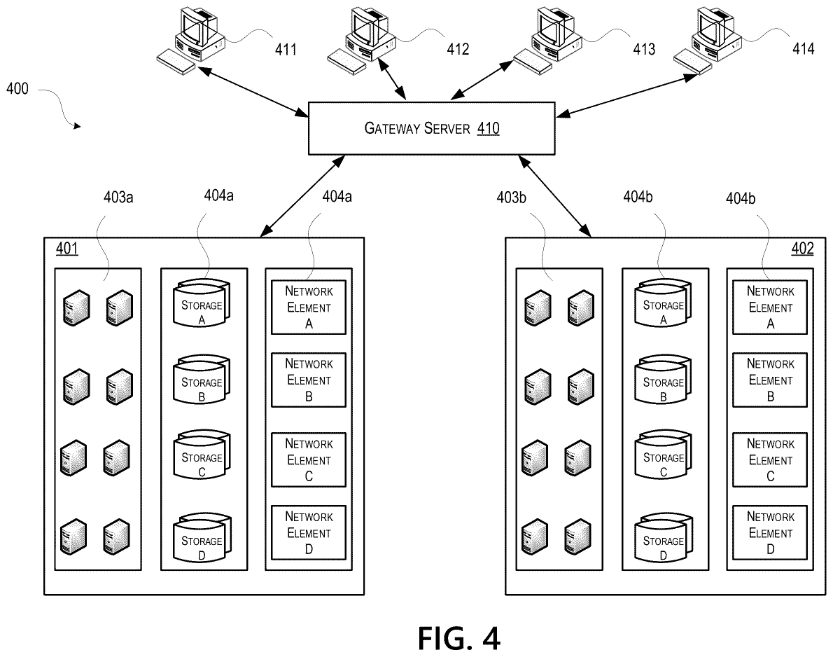

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud data center located in California, and zone 402 may be a second cloud data center located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 may also include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon. com Inc. of Seattle, Washington), IBM BLUE CLOUD (IBM Corporation of Armonk, New York), or others.

### ARCHITECTURE FOR RULE-BASED DATA SHARING BETWEEN APPLICATIONS

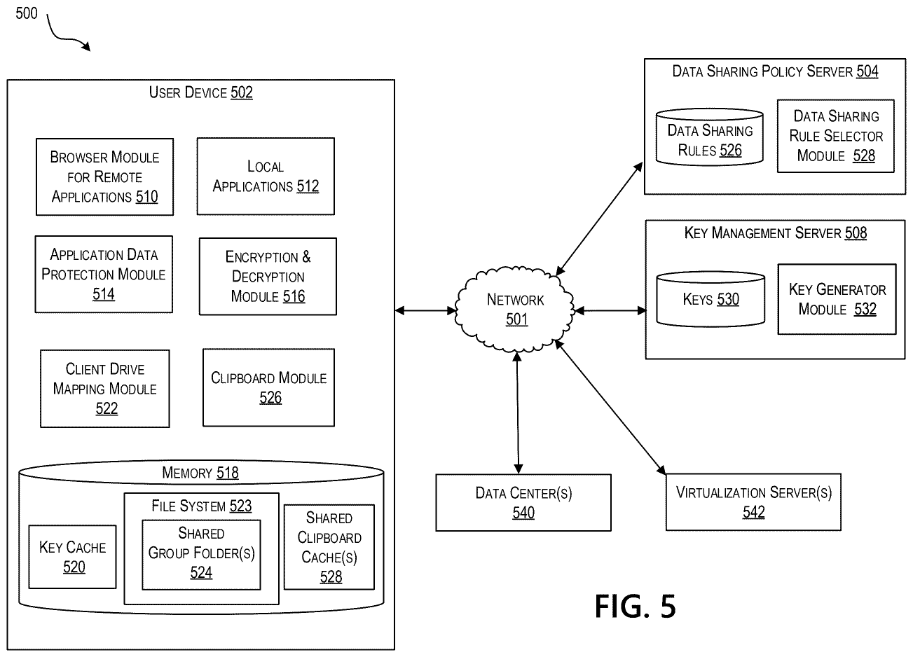

FIG. 5 depicts an illustrative computing environment 500 where applications of a user device 502 may share data based on data sharing rules. The computing environment 500 may include a user device 502, a data sharing policy server 504, a key management server 508, application data center(s) 540, and/or virtualization server(s) 542. While only one user device 502, one data sharing policy server 504, and one key management server 508 are shown in FIG. 5, any number of such devices may be implemented in the methods described herein without departing from the scope of the disclosure

The user device 502, the data sharing policy server 504, the key management server 508, the application data center(s) 540, and/or the virtualization server(s) 542 may communicate via the network 501. The network 501 may comprise private intranets, corporate networks, local area networks (LAN), metropolitan area networks (MAN), wireless networks, personal networks (PAN), Wide Area Network (WAN), the Internet, and the like. The network 501 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

In some examples, the data sharing policy server 504, the key management server 508, the application data center(s) 540, and/or the virtualization server(s) 542 may be physically located within the organization's premises or facilities. Such an on-premise environment may give the organization direct control and ownership over its IT infrastructure, including the physical infrastructure, security measures, and network connectivity. Alternatively, aspects described herein may also be implemented in cloud-based environments where one or more of the data sharing policy server 504, the key management server 508, the application data center(s) 540, and/or the virtualization server(s) 542 may be outside the organization's premises or facilities and in a cloud service provider's data centers. Cloud-based environments may include and provide different types of cloud computing services, for example, Infrastructure as a service (IaaS), Platform as a service (PaaS), server-less computing, and/or Software as a service (SaaS). Examples of IaaS include AMAZON WEB SERVICES provided by Amazon. com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating systems, middleware, or runtime resources. In some embodiments, SaaS providers may offer additional resources including, e.g., data and application resources. Examples of SaaS include GOOGLE APPS provided by Google Inc., SALESFORCE provided by Salesforce. com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple iCloud provided by Apple Inc. of Cupertino, California.

The user device 502 may be a personal computing device such as a smartphone, tablet, laptop computer, desktop computer, or the like. In some embodiments, the user device 502 may be configured to facilitate the use of various types of applications, such as local applications 512 and/or remote applications. The user device 502 may comprise other software components, such as a browser module for remote applications 510, an application data protection module 514, an encryption and decryption module 516, a client drive mapping module 522, and/or a clipboard module 526. The memory 518 of the user device 502 may store data used in the performance of one or more aspects described herein, including a key cache 520, a file system 523 comprising shared group folders 526, and/or shared clipboard caches 528.

The browser module for remote applications 510, when launched by a user, may send a request to an application store for a list of remote applications available to the user associated with the user device 502. The user device 502 may then receive the list of available applications and display the list via the user device 502. Alternatively, a user may open a remote application by trying a website address for the remote application. Upon selection of a remote application, the browser module for remote applications 510 may request initiation and/or execution of the selected remote application at one of the virtualization servers 542 or the data centers 540. Upon selection of one of the local applications 512, the user device 502 may initiate and/or execute the selected local application and access one of the data centers 540 storing data files for the selected local application. The computing environment 500 may also comprise one or more application stores (not shown) for delivering various types of applications (e.g., remote applications and local applications) to the user device 502. The application store may be implemented as any portion of the Citrix Workspace Suite™ by Citrix Systems, Inc., such as Citrix Virtual Apps and Desktops (formerly XenApp® and XenDesktop®).

The application data protection module 514 may be configured to receive one or more data sharing rules from the data sharing policy server 504 and manage how remote and local applications on the user device 502 access data files downloaded or created by the applications in the user device 502 based on the received data sharing rules. The encryption and decryption module 516 may be configured to encrypt data files downloaded or created by the local and remote applications in the user device 502. The encryption and decryption module 516 may be further configured to decrypt data files for a local or remote application if the application data protection module 514 grants permission to the local or remote application to access the content of the data files. The encryption and decryption module 516 will not decrypt data files for the local or remote application if the application data protection module 514 rejects a request from the local or remote application to access the content of the data files. The encryption and decryption module 516 or the application data protection module 514 may receive one or more application keys from the key management server 508 for encrypting and decrypting at least the metadata portion of the data files or the entire data files. The encryption and decryption module 516 or the application data protection module 514 may also generate content keys for encrypting and decrypting at least the content portions of the data files. The encryption and decryption module 516 or the application data protection module 514 may store application keys received from the key management server 508 and/or content keys generated by the user device 502 in the key cache 520. In some aspects, the application keys may be temporarily stored in the key cache. For example, the application keys may be removed from the key cache 520 after a minute, five minutes, an hour, two hours, etc. In other examples, an application key may be removed from the key cache 520 if the application key has not been used for a certain period of time (e.g., a minute, five minutes, an hour, etc.).

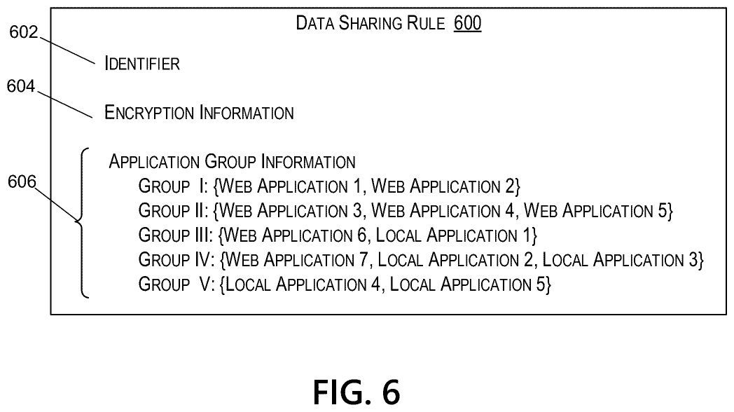

FIG. 6 shows an example data sharing rule 600 that the user device 502 may receive from the data sharing policy server 504. The application data protection module 514 may determine whether an application in the user device can access, read, edit, or use data files downloaded or created by another application in the user device 502 based on the data sharing rule 600. The data sharing rule 600 may be unique to the user device 502 and/or a user of the user device 502. Additionally, the user device may comprise local and/or remote applications from a single application store or multiple application stores, and the data sharing rule 600 may additionally be unique to one of the application stores.

The data sharing rule 600 may comprise various fields that may be used by the user device 502 and/or the data sharing policy server 504 to manage data sharing between applications in the user device 502. For example, the data sharing rule 600 may comprise a unique identifier 602 (of a string data type or a universally unique identifier (UUID)) for the data sharing rule 600 that may be generated by the data sharing policy server 504. The data sharing rule 600 may further include encryption information 604 and application group information 606.

The encryption information 604 may include information about encryption algorithms that the encryption and decryption module 516 of the user device 502 would need to use to encrypt and/or decrypt data files. The encryption algorithm to be applied to the data files may include, for example, Rivest-Shamir-Adleman (RSA), Elliptic-curve Diffie-Hellman (ECDH), Data Encryption Standard (DES), Advanced Encryption Standard (AES), Secure Hash Algorithm (SHA) (e.g., SHA-1, SHA-2, or SHA-3), and Message Digest algorithm (e.g., MD5), among others. The encryption information 604 may further indicate whether the user device should use a symmetric key for encrypting and decrypting data files or asymmetric keys, such as a pair of keys comprising a public key and a private key.

The application group information 606 may comprise multiple groups of applications. For example, the data sharing rule 600 comprises information about five different groups of applications, groups I, II, III, IV, and V. A group of applications may include only remote applications. For example, group I includes remote application 1 and remote application 2, and group II includes remote application 3, remote application 4, and remote application 5. Additionally, a group of applications may include only local applications. For example, group V includes local application 4 and location application 5. Alternatively, and additionally, a group of applications may include both remote and local applications. For example, group III includes remote application 6 and remote application 1, and group IV includes remote application 7, local application 2, and local application 5. One skilled in the art will recognize that, although groups I, II, III, VI, and V are provided as examples, the data sharing rule 600 and/or application group information section 606 may, in various embodiments, include fewer or more than 5 groups. Furthermore, each group may include zero, one, or a plurality of applications.

Applications included in a certain group may share data files downloaded or created by other applications in that group. However, there may be a restriction in data sharing between applications of different groups. For example, remote application 1 of group I can access data files downloaded or created by remote application 2 of group I, and remote application 2 of group I can access data files downloaded or created by remote application 1 of group I. However, remote application 3, remote application 4, and remote application 5 of group II, remote application 6 and local application 1 of group III, remote application 7, local application 2, and local application 5 of group IV, and local application 4 and location application 5 of group V may not be able to access data files downloaded or created by remote application 1 and remote application 2 of group I. Additionally, remote application 1 and remote application 2 of group I may not be able to access data files downloaded or created by remote application 3, remote application 4, and remote application 5 of group II, remote application 6 and local application 1 of group III, remote application 7, local application 2, and local application 5 of group IV, and local application 4 and location application 5 of group V. As another example, remote application 6 of group III may access data files downloaded or created by local application 1 of group III, and local application 1 of group III may access data files downloaded or created by remote application 6 of group III. However, remote applications and local applications of the other groups I, II, IV, and V may not be able to access data files downloaded or created by remote application 6 and local application 1 of group III.

Referring back to FIG. 5, the application data protection module 514 may be further configured to determine parameters associated with the user device 502, such as the current configurations, status, and/or location of the user device 502. Such parameters may be used by the data sharing policy server 504 to choose an appropriate data sharing rule for the user device 502. The application data protection module 514 may also perform end-point detection/scanning and collect end-point information about the user device 502 for the data sharing policy server 504. The data sharing policy server 504 may use the collected information to select a data sharing rule for the user device 502. For example, the application data protection module 514 may identify and determine the user currently using the user device 502, one or more user device parameters, such as the operating system and/or a version of an operating system, a service pack of the operating system, presence or versions of various applications of the client, such as antivirus, firewall, security, and/or other software, whether the user device 502 has joined a private domain of an organization, whether the user device 502 is connected to a public network or a private network, such as a home network, whether the user device 502 comprises a certificate associated with the private domain or organization, the physical location of the user device, etc.

The client drive mapping module 522 may map file system paths between the file system 523 on the user device 502 and one or more virtualization server 542 running remote applications. Files downloaded from the virtualization servers for the remote applications may be stored in the file system 523. Files downloaded from virtualization servers 542 to the file system 523 may be subject to the data sharing policies in the data sharing rule. Furthermore, the client drive mapping module 522 may enable data files downloaded or created by members of a group of applications to be stored in one of the shared group folders 524 in memory 518 dedicated to that particular group of applications. For example, each group of applications I, II, III, IV, and V in the data sharing rule 600 may have its own shared group folder 524. Remote applications that are running in the virtualization servers 542 and are members of a group of applications can access data files stored in one of the shared group folders 524 dedicated to that particular group of applications. In various examples, applications that are not included in the groups of applications would not be able to access data files stored in that dedicated shared group folder. An application (e.g., a remote application or a local application) may issue read operations and write operations to a data file in one of the shared group folders 524. The read and write operations may be intercepted by the client drive mapping module 522. If the client drive mapping module 522 determines that the read and/or write operations are directed to one of the shared group folders 524 dedicated to the group the application belongs to, the client drive mapping module 522 may allow the read and/or write operations. Any data written to the data file through the write operations may be encrypted by the encryption and decryption module 516 before storing the data in a data file in the dedicated shared group folder. In some example, any encrypted data that would be accessed in the dedicated shared group folder by read operations would be decrypted by the encryption and decryption module 516, and then client drive mapping module 522 would send the decrypted data to the application. Different keys, such as application keys and content keys, may be used for encrypting/decrypting data to/from the dedicated shared group folder.

User devices may comprise a mechanism typically called the “clipboard” or “pasteboard” that is used to share data between applications. A user may “copy” data from one application into the clipboard and then “paste” it from the clipboard into a second application. One problem is that the data put into the clipboard is often not secured in any way, and sometimes, there is a need to secure the data in a clipboard such that only a defined set of applications may share this data. The clipboard module 526 may enable members of a group of applications to access data (e.g., copy data or paste data) in an encrypted clipboard dedicated to that particular group of applications. Applications that are not members of that particular group of applications may not be able to access the encrypted clipboard.

The memory 518 of the user device 502 may comprise multiple shared clipboard caches 528, where each of the shared clipboard caches 528 is dedicated to one group of applications. In some arrangements, the clipboard module 526 may equip different groups of applications to use different secure clipboards. For example, the clipboard module 526 may provide (i) a first memory address of the secure clipboard and a first set of keys to a first group of applications, (ii) a second memory address to another secure clipboard and a second set of keys to a second group of applications, and so on. For example, the clipboard module 526 may provide a different shared clipboard cache for each of the groups I, II, III, IV, and V in the data sharing rule 600 in FIG. 6.

The data sharing policy server 504 may store data sharing rules for group-based data sharing amongst applications in the user device 502 and other user devices. The data sharing policy server 504 may comprise various software components, such as a data sharing rule selector 528. The data sharing policy server 504 may also include a data sharing rules database 526 for storing data sharing rules. The data sharing rules in the data sharing rules database 526 may be stored or provided by a network administrator of an organization. The data sharing rules may be based on one or more policies can limit data sharing amongst applications based on various settings or definitions such as, for example, (1) which user and user device is requesting access, (3) time or date, (4) geographical position of the user device, (5) whether the user device provides a correct certificate or credentials, (6) whether the user of the user device provides correct credentials, (8) other conditions, or any combination thereof. Temporal and geographic restrictions on data sharing may be useful in some variations. For example, a network administrator may deploy a policy that restricts the sharing of the data to a specified time window and/or a geographic zone of the user device.

In certain embodiments, the data sharing rule selector 528 may receive a request from the user device 502 for a data sharing rule for the user device 502. The request from the user device 502 may comprise a device identifier for the user device 502, a user identifier for the user of the user device 502, and/or a store identifier for an application store that provided the application to the user device 502. A user identifier may comprise a user's first name, last name, full name, email address, picture, a unique icon, a unique alphanumeric string, or a combination thereof. Examples of a device identifier include Android identifier (ID), iPhone's Unique Identifier (UDID), iPhone's IdentifierForAdvertising (IFA or IDFA), cookie ID, login ID, Internet Protocol (IP) address, media access control (MAC) address, a hash of any of the above, a combination of any of the above, or the like.

The data sharing rule selector 528 may select a data sharing rule from the data sharing rules database 526 that is associated with the user identifier, the device identifier, and/or the store identifier. The data sharing rule selector 528 may determine what type of user is currently using the user device 502 based on the user identifier. For example, the user identifier may indicate that the user is a manager, an executive, a network administrator, an engineer, a human resource specialist, etc. The device identifier may indicate what type of user device is asking for the data sharing rule. For example, the device identifier may indicate whether the user device is a corporate-issued device or an unmanaged personal device. Based on the user type and/or the user device type, the data sharing rule selector 528 may select a data sharing rule for the user device 502 and then send the selected data sharing rule to the user device 502.

Referring back to FIG. 5, the key management server 508 may generate and manage encryption and/or decryption keys for group-based data sharing amongst applications in the user device 502. The key management server 508 may comprise various software components, such as a key generator module 532. The key management server 508 may also include a keys database 530 for storing previously generated application keys. In certain embodiments, the key generator module 532 may receive a request from the user device 502 for an application key that the user device 502 will use to encrypt and decrypt data files downloaded or created by the application in the user device 502. The request from the user device 502 may comprise a device identifier for the user device 502, a user identifier for the user of the user device 502, an application identifier for the application downloading or creating the data files, and/or a store identifier for an application store that provided the application to the user device 502. The key generator module 532 may determine if a key that is associated with the user identifier, the device identifier, the application identifier, and/or the store identifier is stored in the database 530. Otherwise, the key generator module 532 may generate an application key that is unique for the user identifier, the device identifier, the application identifier, and the store identifier combination. Once the application key is generated for the user device, it can be stored for future use in the database 530. In one embodiment implementing symmetric key cryptography, the key generator module 532 may generate a single symmetric key (used for both encryption and decryption) to be used as the application key. Alternately or additionally, the key generator module 532 can generate two cryptographic keys (e.g., one key for encryption and a complementary key for decryption) to be used as application keys when asymmetric key cryptography is implemented.

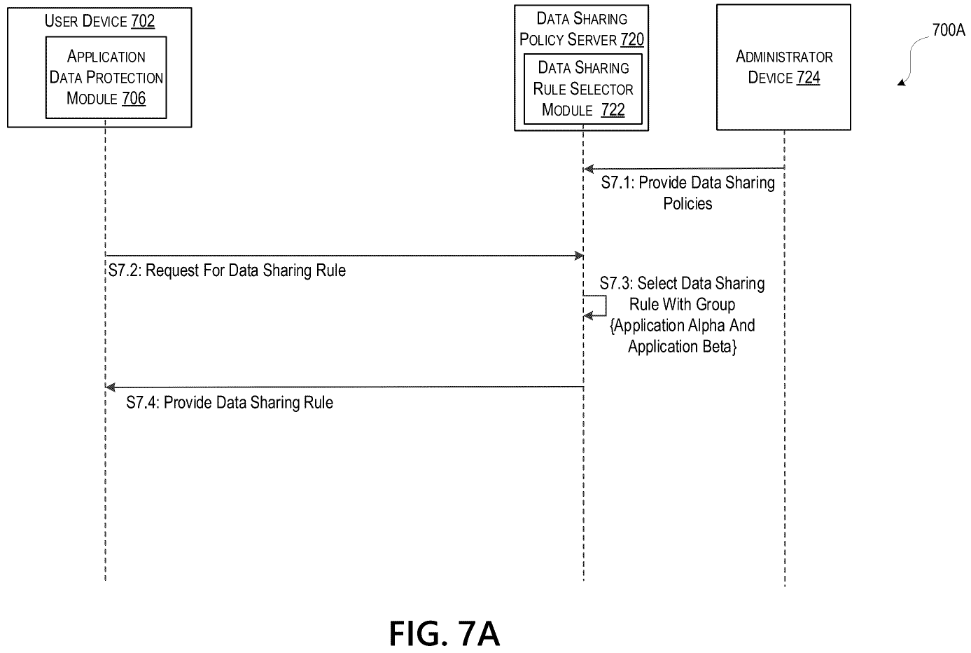

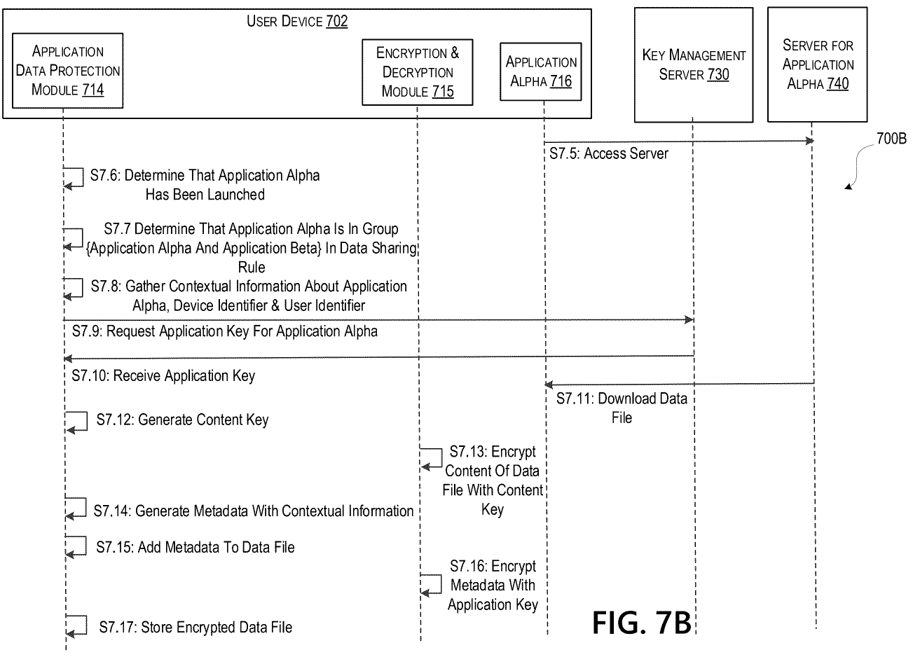

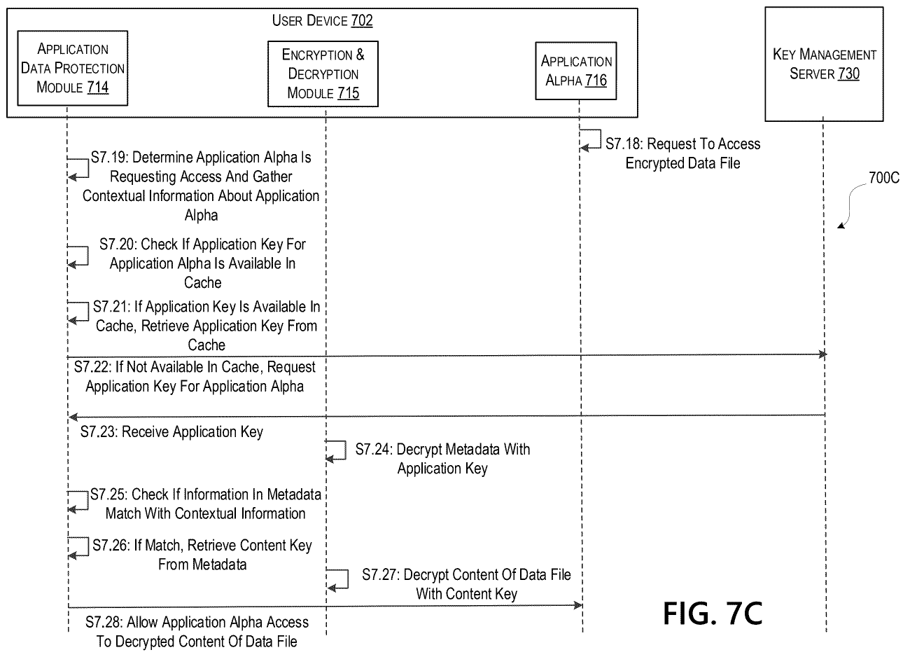

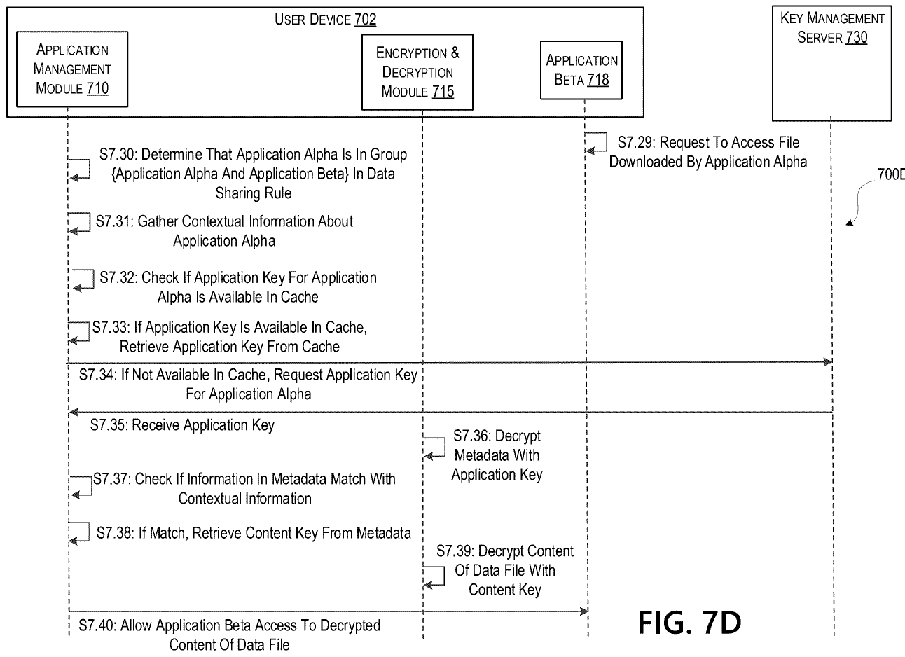

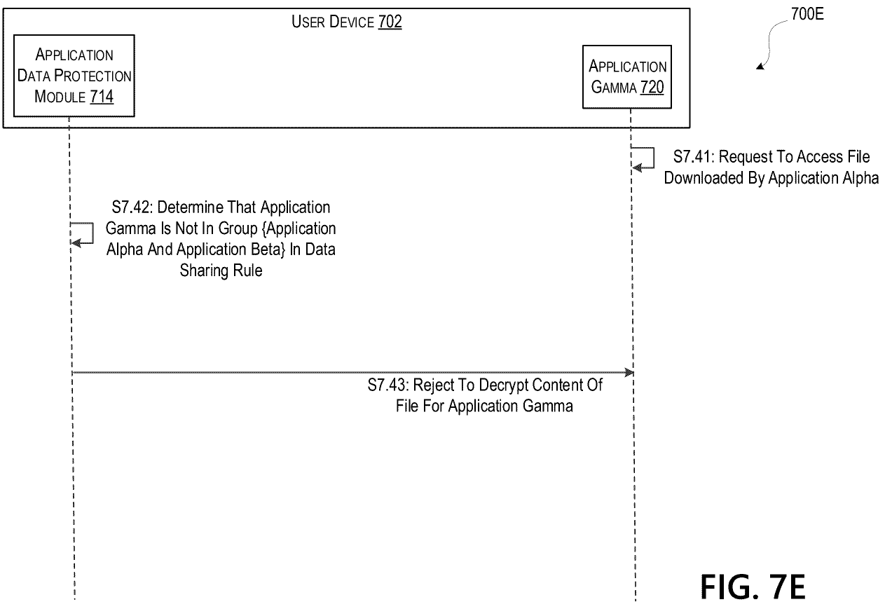

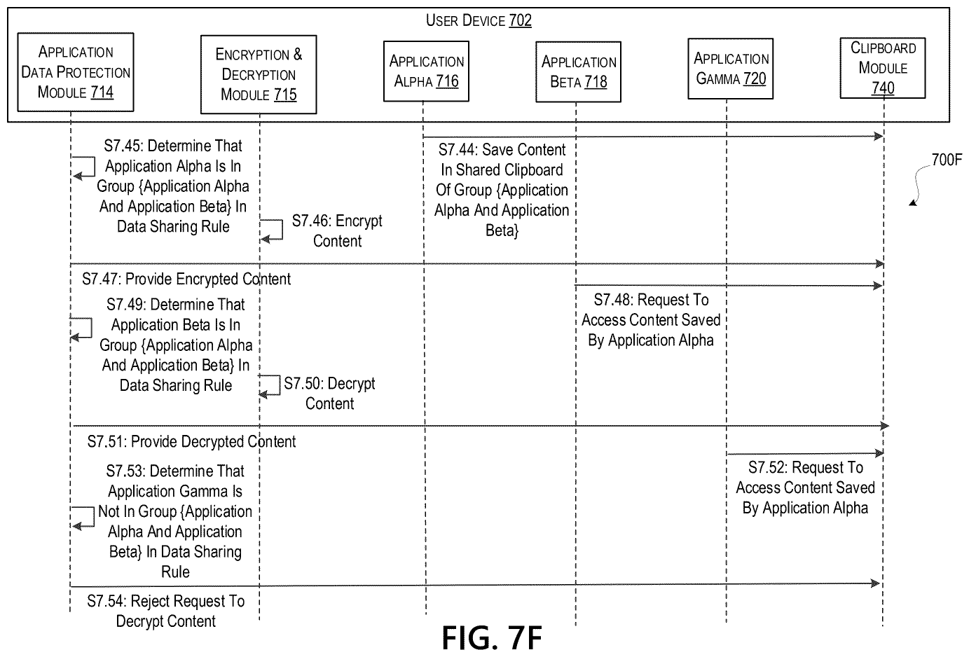

FIG. 7A depicts an illustrative event sequence 700A illustrating a method for providing one or more data sharing rules (e.g., the data sharing rule 600) to a user device 702 (e.g., the user device 502) by a data sharing policy server 720 (e.g., the data sharing policy server 504) in accordance with one or more illustrative aspects described herein. The actions in the event sequence 700A or other event sequences described herein may be performed in different orders and with different, fewer, or additional actions than those illustrated. Multiple actions can be combined in some implementations.

The event sequence 700A may begin at step S7.1, where an administrator device 724 (e.g., a user device belonging to a network administrator of an organization) may use administrative privilege to provide different data sharing rules to the data sharing policy server 720. The data sharing rules may be structured based on types of users (e.g., C-suite executives, managers, engineers, administrative employees, etc.) and types of user devices being used (e.g., corporate-issued laptops, unmanaged devices, etc.). For example, one of the data sharing rules may indicate that remote applications 1, 2, 3, and 4 and local application 1 can share data in a user device only if the user device belongs to a manager of an organization and if the manager is currently using his or her corporate issued user device. Otherwise, in the case of a non-manager or if the manager is not using his corporate-issued user device, only remote application 1 and local application 1 can share data. The data sharing rules may be saved by the data sharing policy server 720 in a database (e.g., the data sharing policies database 526).

At step S7.2, the application data protection module 706 (e.g., the application data protection module 514) of the user device 702 may send a request to the data sharing policy server 720 for a data sharing rule for the user device 702. The application data protection module 706 may send the request to the data sharing policy server 720 when the user device 702 is turned on. Additionally, or alternatively, the application data protection module 706 may send the request to the data sharing policy server 720 periodically (e.g., once every 2 hours, once a day, once a week, once a month, etc.). The request may comprise various identifiers that would be needed by the data sharing policy server 720 to select or generate a data sharing rule for the user device 702. For example, the request may comprise a device identifier of the user device 702, a user identifier of a user of the user device 702, and/or a store identifier for an application store providing applications (e.g., remote application or local applications) to the user device 702.

At step S7.3, the data sharing policy server 720 may select a data sharing rule based on the device identifier, the user identifier, and/or the store identifier. For example, the data sharing policy server 720 may select a data sharing rule that includes a group {application alpha, application beta} comprising application alpha and application beta. Application alpha may be either a local application or a remote application. Similarly, application beta may be either a local application or a remote application. At step S7.4, the data sharing policy server 720 may send the selected data sharing rule to the application data protection module 706 of the user device 702.

FIG. 7B depicts an illustrative event sequence 700B illustrating a method for downloading files by an application in accordance with one or more illustrative aspects described herein. At step S7.5, application alpha 716 (included in the group in the data sharing rule received in step S7.4) may launch and access a server 740 associated with the application alpha. Application alpha 716 may be a local application, and the server 740 may be a data center (e.g., one of the data centers 540). Alternatively, application alpha 716 may be a remote application, and the server 740 may be a data center (e.g., one of the data centers 540) or a virtualization server (e.g., one of the virtualization servers 542). At step S7.6, the application data protection module 714 may determine that application alpha 716 has been launched. At step S7.7, the application data protection module 714 may determine that application alpha 716 is a member of group {application alpha, application beta}. At step S7.8, the application data protection module 714 may determine contextual information about application alpha 716. The contextual information may comprise an application identifier for application alpha 716 and/or a store identifier for an application store that provided application alpha 716 to the user device 702. Additionally, the application data protection module 714 may gather information about a user identifier for a user currently using the user device 702 and/or a device identifier for the user device 702. In some embodiments, if application alpha 716 is a remote application that is being accessed by a browser (e.g., the browser module for remote applications 510), steps S7.6, S7.7, and/or S7.8 may be performed by the browser and the contextual information gathered at step S7.8 be provided to the application data protection module 714.

At step S7.9, the application data protection module 714 may send a request to the key management server 730 (e.g., the key management server 508) for an application key for application alpha 716. The request to the key management server 730 may comprise the user identifier, the device identifier, the application identifier for application alpha 716, and/or the store identifier. At step S7.10, the application data protection module 714 may receive an application key for application alpha 716 from the key management server 730.

At step S7.11, application alpha 716 may download a data file from the server 740. The downloaded data file may be unencrypted. At step S7.12, the application data protection module 714 may generate a content key for encrypting the content portion of the downloaded data file from S7.11. The generated content key may based on one of the following encryption algorithms: Rivest-Shamir-Adleman (RSA), Elliptic-curve Diffie-Hellman (ECDH), Data Encryption Standard (DES), Advanced Encryption Standard (AES), Secure Hash Algorithm (SHA) (e.g., SHA-1, SHA-2, or SHA-3), and Message Digest algorithm (e.g., MD5), among others. The content key may be a symmetric key, which can be later also used to decrypt the encrypted content of the data file. At step S7.13, the encryption and decryption module (e.g., the encryption and decryption module 516) may encrypt the content portion of the downloaded data file with the generated content key.

At step S7.14, the application data protection module 714 may generate metadata for the data file. The metadata may comprise the user identifier of the user who downloaded the data file, the device identifier of the user device 702, the application identifier of application alpha 716, the store identifier of the application store that provided application alpha 716, and/or the content key. At step S7.15, the application data protection module 714 may add the metadata to the data file in which the content portion is already encrypted. At step S7.16, the encryption and decryption module 715 may encrypt the metadata portion of the data file with the application key for application alpha 716 received at step S7.10. At step S7.17, the application data protection module 714 may store the data file. The data file may be stored in a shared group folder dedicated to group {application alpha, application beta} (e.g., one of the shared group folders 524).

FIG. 7C depicts an illustrative event sequence 700C illustrating a method for accessing a data file downloaded by application alpha 716 in accordance with one or more illustrative aspects described herein. At step S7.18, application alpha 716 may send a request to access the data file downloaded in step S7.11, encrypted in steps S7.13 and S7.16, and stored in step S7.17. At step S7.19, the application data protection module 714 may determine that application alpha 716 has requested to access the data file, and that application alpha 716 is a member of group {application alpha, application beta}. Additionally, the application data protection module 714 may determine contextual information about application alpha 716. The contextual information may comprise an application identifier for application alpha 716 and/or a store identifier for an application store that provided application alpha 716 to the user device 702. Additionally, the application data protection module 714 may gather information about a user identifier for a user currently using the user device 702 and/or a device identifier for the user device 702. In some embodiments, if application alpha 716 is a remote application that is being accessed by a browser (e.g., the browser module for remote applications 510), step S7.19 may be performed by the browser and the contextual information gathered at step S7.8 be provided to the application data protection module 714.

At step S7.20, the application data protection module 714 may determine if the application key for application alpha 716 is stored in cache (e.g., in key cache 529). At step S7.21, the application data protection module 714 may retrieve the application key for application alpha 716 from cache if it is available in cache. Otherwise, if the application key for application alpha 716 is not available in cache, at step S7.22, the application data protection module 714 may send a request to the key management server 730 (e.g., the key management server 508) for an application key for application alpha 716. The request to the key management server 730 may comprise the user identifier, the device identifier, the application identifier for application alpha 716, and/or the store identifier. At step S7.23, the application data protection module 714 may receive an application key for application alpha 716 from the key management server 730.

At step S7.24, the encryption and decryption module 715 may decrypt the metadata portion of the data file with the application key for application alpha 716. At step S7.25, the application data protection module 714 may determine if the information in the decrypted metadata portion matches the contextual information gathered for application alpha 716. For example, the application data protection module 714 may determine whether the user identifiers in the contextual information and the metadata match, whether the device identifiers in the contextual information and the metadata match, whether the application identifiers in the contextual information and the metadata match, and/or whether the store identifiers in the contextual information and the metadata match. If there is no match, the application data protection module 714 may reject the application alpha 716's request to access the content of the encrypted data file. If there is a match, at step S7.26, the content key may be retrieved from the decrypted metadata portion, and at step S7.27, the encryption and decryption module 715 may decrypt the content portion of the data file with the retrieved content key. At step S7.28, the application data protection module 714 may allow application alpha 716 to access the decrypted content portion of the data file.

FIG. 7D depicts an illustrative event sequence 700D illustrating a method for accessing a data file downloaded by application beta 718 in accordance with one or more illustrative aspects described herein. At step S7.29, application beta 718 may attempt to access the data file downloaded in step S7.11, encrypted in steps S7.13 and S7.16, and stored in step S7.17. At step S7.30, the application data protection module 714 may determine that application beta 718 has requested to access the data file and that application beta 718 is a member of group {application alpha, application beta}. Additionally, at step S7.31, the application data protection module 714 may determine contextual information about application alpha 716 as the data file was downloaded by application alpha 716. The contextual information may comprise an application identifier for application alpha 716 and/or a store identifier for an application store that provided application alpha 716 to the user device 702. Additionally, the application data protection module 714 may gather information about a user identifier for a user currently using the user device 702 and/or a device identifier for the user device 702. In some embodiments, if application beta 718 is a remote application that is being accessed by a browser (e.g., the browser module for remote applications 510), steps S7.30 and S7.31 may be performed by the browser and the contextual information gathered at step S7.31 may be provided to the application data protection module 714.

At step S7.32, the application data protection module 714 may determine if the application key for application alpha 716 is stored in cache (e.g., in key cache 529). At step S7.33, the application data protection module 714 may retrieve the application key for application alpha 716 from cache if it is available. Otherwise, if the application key for application alpha 716 is not available in cache, at step S7.34, the application data protection module 714 may send a request to the key management server 730 (e.g., the key management server 508) for an application key for application alpha 716. The request to the key management server 730 may comprise the user identifier, the device identifier, the application identifier for application alpha 716, and/or the store identifier. At step S7.35, the application data protection module 714 may receive an application key for application alpha 716 from the key management server 730.

At step S7.36, the encryption and decryption module 715 may decrypt the metadata portion of the data file with the application key for application alpha 716. At step S7.37, the application data protection module 714 may determine if the information in the decrypted metadata portion matches the contextual information gathered for application alpha 716. For example, the application data protection module 714 may determine whether the user identifiers in the contextual information and the metadata match, whether the device identifiers in the contextual information and the metadata match, whether the application identifiers in the contextual information and the metadata match, and/or whether the store identifiers in the contextual information and the metadata match. If there is no match, the application data protection module 714 may reject the application beta 718's request to access the content of the encrypted data file. If there is a match, at step S7.38, the content key may be retrieved from the decrypted metadata portion, and at step S7.39, the encryption and decryption module 715 may decrypt the content portion of the data file with the retrieved content key. At step S7.40, the application data protection module 714 may allow application beta 718 access to the decrypted content portion of the data file.

FIG. 7E depicts an illustrative event sequence 700E illustrating a method for accessing a data file downloaded by application gamma 720 in accordance with one or more illustrative aspects described herein. At step S7.41, application gamma 720 may attempt to access the data file downloaded in step S7.11 by application alpha 716, encrypted in steps S7.13 and S7.16, and stored in step S7.17. At step S7.42, the application data protection module 714 may determine that application gamma 720 has requested to access the data file, and that application beta 718 is not a member of group {application alpha, application beta}. Therefore, at step S7.43, the application data protection module 714 may reject to decrypt the content portion of the data file for application gamma 720.

FIG. 7F depicts an illustrative event sequence 700F illustrating a method for accessing a shared clipboard of group {application alpha, application beta} in accordance with one or more illustrative aspects described herein. At step S7.44, application alpha 716 may send a request to the clipboard module 740 (e.g., the clipboard module 526) to save content in the shared clipboard of group {application alpha, application beta}. At step S7.45, the application data protection module 714 may determine that application alpha 716 is a member of group {application alpha, application beta}. Therefore, at step S7.46, the encryption and decryption module 715 may encrypt the content, and at step S7.47, the application data protection module 714 may send the encrypted content to the clipboard module 740 for saving the encrypted content in the shared clipboard of group {application alpha, application beta}. The encrypted content may be stored in a shared clipboard cache for group {application alpha, application beta} (e.g., one of the shared clipboard caches 528). The encryption and decryption module 715 may encrypt the content with an application key for application alpha stored in cache (e.g., in key cache 529) or received from the key management server 730 (e.g., the key management server 508). Alternatively, the encryption and decryption module 715 may encrypt the content with an application key for the clipboard module 740.

At step S7.48, application beta 718 may send a request to the clipboard module 740 to access content in the shared clipboard of group {application alpha, application beta} saved by application alpha 716. At step S7.49, the application data protection module 714 may determine that application beta 718 is a member of group {application alpha, application beta}. Therefore, at step S7.50, the encryption and decryption module 715 may decrypt the content, and at step S7.51, the application data protection module 714 may send the decrypted content to the clipboard module 740 for providing the decrypted content to application beta 718. The encryption and decryption module 715 may decrypt the content with an application key for application alpha stored in cache (e.g., in key cache 529) or received from the key management server 730 (e.g., the key management server 508). Alternatively, the encryption and decryption module 715 may decrypt the content with an application key for the clipboard module 740.

At step S7.52, application gamma 720 may send a request to the clipboard module 740 to access content in the shared clipboard of group {application alpha, application beta} saved by application alpha 716. At step S7.53, the application data protection module 714 may determine that application gamma 720 is not a member of group {application alpha, application beta}. Therefore, at step S7.54, the application data protection module 714 may inform the clipboard module 740 that the encrypted content will not be decrypted for application gamma 720.

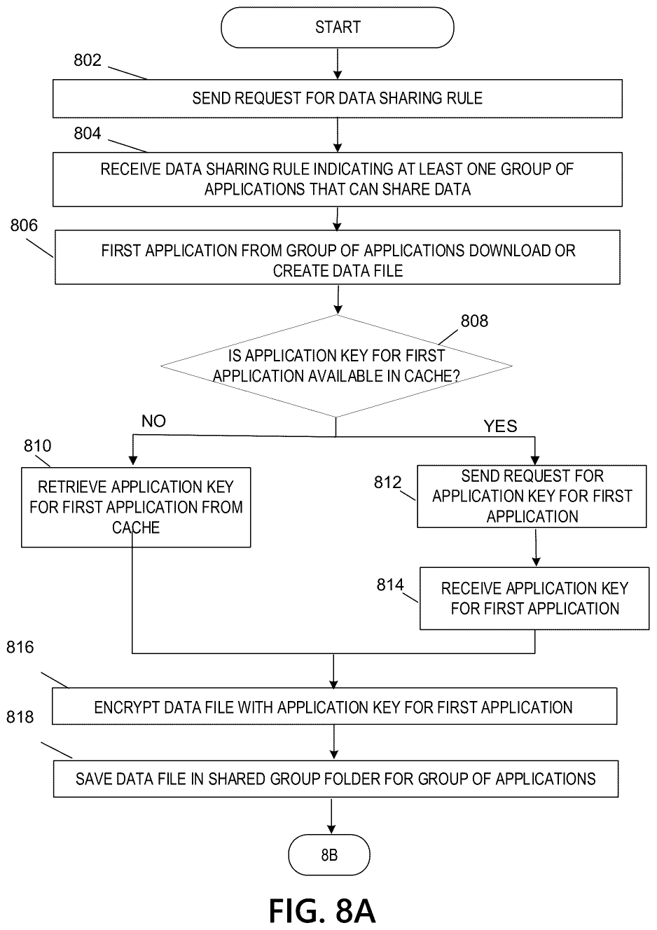

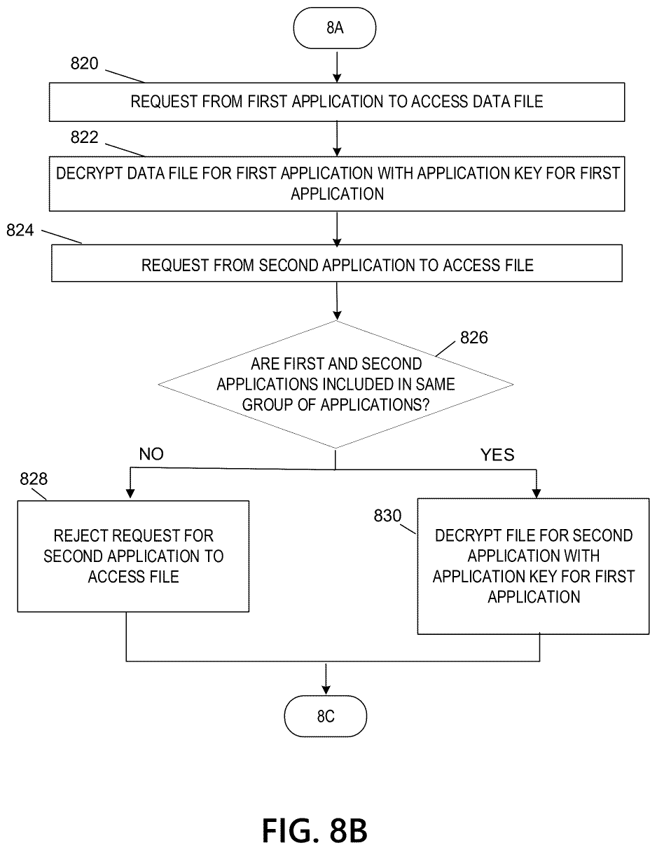

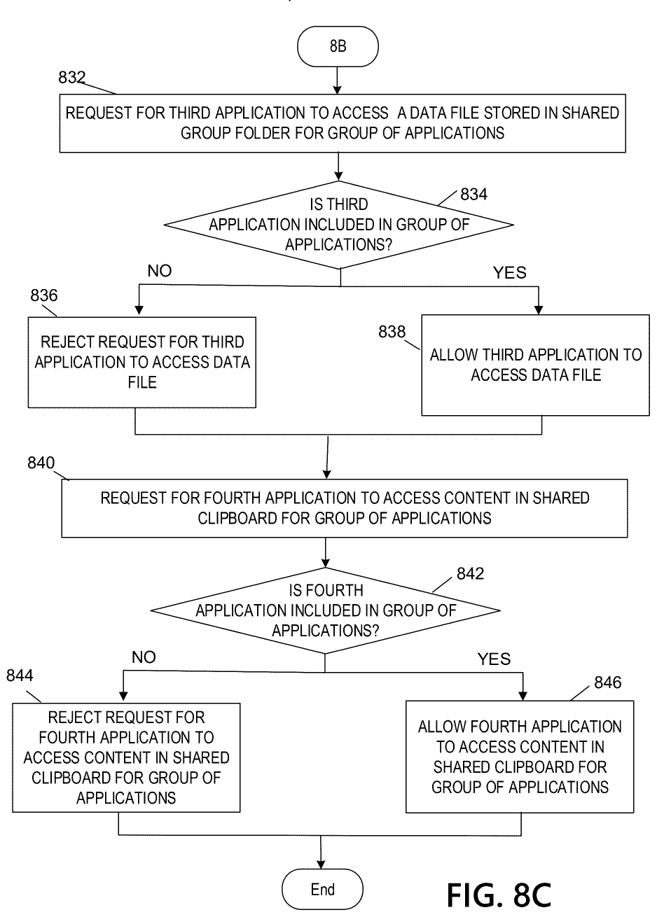

FIGS. 8A, 8B, and 8C depict illustrative methods for managing data sharing between applications in a user device in accordance with one or more illustrative aspects described herein. For convenience, steps 802-848 are shown across FIGS. 8A-8C. However, it should be understood that steps 802-848 represent a single method (e.g., step 820 in FIG. 8B may follow step 818 in FIG. 8A). The various steps may be performed by user device 502 or any other desired computing device.

At step 802 in FIG. 8A, a computing device (e.g., the user device 502) may send a request to a data sharing policy server (e.g., the data sharing policy server 504) for a data sharing rule associated with the computing device. The computing device may send the request to the data sharing policy server when the computing device is turned on. Additionally, or alternatively, the computing device may send the request to the data sharing policy server periodically (e.g., once every 2 hours, once a day, once a week, once a month, etc.). The request may comprise various identifiers that the data sharing policy server would need to select or generate a data sharing rule. For example, the request may comprise a device identifier of the computing device, a user identifier of a user of the computing device, and/or a store identifier for an application store providing applications (e.g., remote application or remote applications) to the computing device. At step 804, the computing device may receive a data sharing rule from the data sharing policy server. The selected data sharing rule may be based on the device identifier, the user identifier, and/or the store identifier. The data sharing rule may include information for a plurality of groups of applications. Applications in each group of applications can share data amongst each other.

At step 806, a first application (e.g., a remote application or a local application) may download a data file or create a new data file. The first application may belong to one of the groups of applications indicated in the data sharing rile received at step 804. At step 808, the computing device may determine whether an application key associated with the first application is available in the cache (e.g., in the key cache 520). If the application key for the first application is available in the cache, at step 810, the computing device may retrieve the application key from the cache. Otherwise, if the application key for the first application is not available in cache, at step 812, the computing device may send a request to a key management server (e.g., the key management server 508) for an application key for the first application. The request to the key management server may comprise the user identifier of a user of the computing device, the device identifier of the computing device, the application identifier for the first application, and/or the store identifier of an application store from where the first application is available. At step 814, the computing device may receive an application key for the first application from the key management server.

At step 816, the computing device may encrypt at least a portion of the data file downloaded or created at step 806. In some examples, the computing device may encrypt the entire data file. At step 818, the computing device may store the encrypted data file in a shared group folder associated with the group of applications the first application belongs to (e.g., in one of the shared group folders 528).

At step 820 in FIG. 8B, the computing device may receive a request from the first application to access the data file. At step 822, as the non-encrypted version of the data file was created or downloaded by the first application, the computing device may decrypt the data file with the application key of the first application such that the first application can access the content of the data file. The computing device may decrypt a portion of the data file or the entire data file. Before decrypting the data file, the computing device may check whether the application key for the first application is still available in the cache. If not, the computing device may request the application key again from the key management server.

At step 824, the computing device may receive a request from a second application (e.g., a remote application or a remote application) to access the content of the data file initially downloaded or created by the first application. At step 826, the computing device may determine whether the first application and the second application both belong to at least one of the groups of applications indicated in the data sharing rule received at step 804. If the first application and the second application do not belong to the same group of applications, the computing device may reject the request from the second application to access the content of the data file at step 828. Alternatively, or additionally, the computing device may decide not to decrypt the data file for the second application. However, if the first application and the second application belong to the same group of applications, the computing device, at step 830, may decrypt the data file with the application key of the first application such that the second application can access the content of the data file. The computing device may decrypt a portion of the data file or the entire data file. Before decrypting the data file, the computing device may check whether the application key for the first application is still available in the cache. If not, the computing device may request the application key again from the key management server.

At step 832 in FIG. 8C, the computing device may receive a request from a third application to access the content of a data file stored in a shared group folder of a group of applications included in the data sharing rule received at step 804. At step 834, the computing device may determine whether the third application is included as a member of the group of applications associated with the shared group folder. If the third application is not a member of the group of applications, the computing device may reject the request from the third application to access the content of the data file at step 836. Alternatively, or additionally, the computing device may decide not to decrypt the data file for the third application. However, if the third application is a member of the group of applications, at step 838, the computing device may decrypt the data file such that the third application can access the content of the data file. The computing device may decrypt a portion of the data file or the entire data file. Before decrypting the data file, the computing device may determine which application has downloaded or created the data file and retrieve the application key for that particular application from the cache or request the application key again from the key management server.

At step 840, the computing device may receive a request from a fourth application to access the content of a clipboard associated with a group of applications included in the data sharing rule received at step 804. At step 842, the computing device may determine whether the fourth application is included as a member of the group of applications associated with the shared group folder. If the fourth application is not a member of the group of applications, the computing device may reject the request from the fourth application to access the content of the clipboard associated with the group of applications at step 844. Alternatively, or additionally, the computing device may decide not to decrypt the content of the clipboard for the fourth application. However, if the fourth application is a member of the group of applications, at step 846, the computing device may decrypt the content of the clipboard belonging to the group of applications such that the fourth application can access the content of the clipboard.

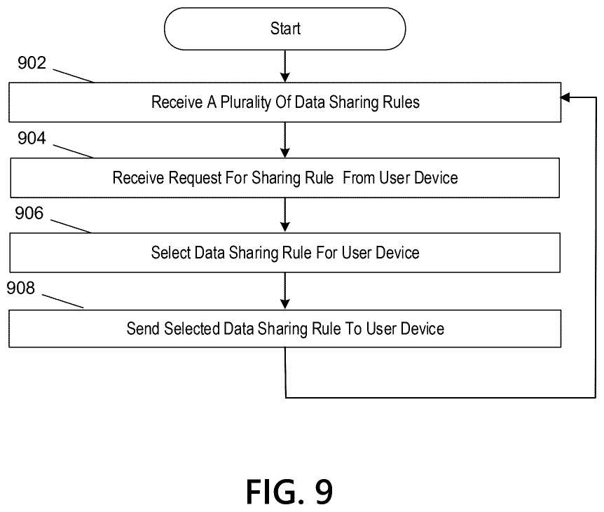

FIG. 9 depicts illustrative methods for providing data sharing rules in accordance with one or more illustrative aspects described herein. The various steps may be performed by the data sharing policy server 504 or any other desired computing device.

At step 902, a computing device may receive a plurality of data sharing rules from one or more administrator devices (e.g., a user device belonging to a network administrator of an organization). The administrator devices may use administrative privilege to provide the plurality of data sharing rules to the computing device. The different data sharing policies may be based on types of users (e.g., C-suite executives, managers, engineers, administrative employees, etc.) and/or types of user devices being used (e.g., corporate-issued laptops, unmanaged devices, etc.). At step 904, the computing device may receive a request from a user device for a data sharing rule for the user device. The request may comprise various identifiers that would be needed by the computing device to select a data sharing rule for the user device. For example, the request may comprise a device identifier of the user device, a user identifier of a user of the user device, and/or a store identifier for an application store providing applications (e.g., remote application or remote applications) to the user device. At step 906, the computing device may select a data sharing rule based on the device identifier, the user identifier, and/or the store identifier. At step 908, the computing device may send the selected data sharing rule to the user device. The selecting data sharing rule may indicate which applications in the user device may share data and which applications cannot share data.

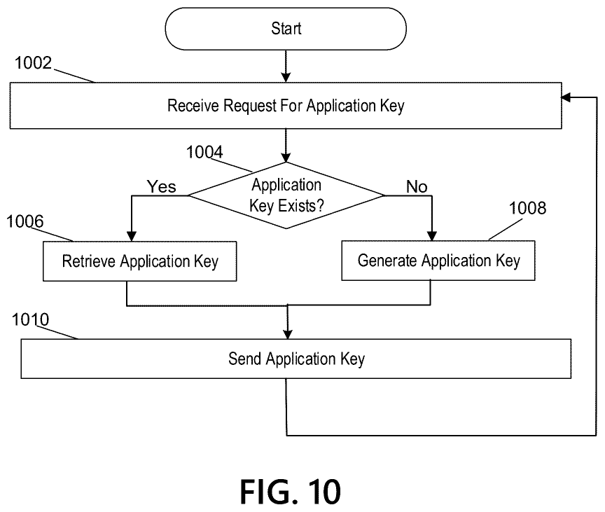

FIG. 10 depicts illustrative methods for providing encryption and decryption keys in accordance with one or more illustrative aspects described herein. The various steps may be performed by key management server 508 or any other desired computing device.

At step 1002, a computing device may receive a request from a user device (e.g., the user device 502) for an application key for an application (e.g., a remote application, a local application, or the clipboard module 740) present in the user device. The request may include a user identifier for a user of the user device, the device identifier of the user device, the application identifier for the application for which the application key is requested, and/or the store identifier of an application store from which the application is available. At step 1004, the computing device may determine whether an application key exists in memory (e.g., in the keys database 530) that corresponds to the received user identifier, device identifier, application identifier, and/or store identifier or unique to the user identifier, device identifier, application identifier, and store identifier combination. If an application key exists in memory, the computing device may retrieve the application key from memory at step 1006. Otherwise, if an application key does not exist in memory, at step 1008, the computing device may generate a new application key that uniquely corresponds to the received user identifier, device identifier, application identifier, and/or store identifier. The generated key may be a symmetric key. At step 1010, the computing device may send the application key to the user device.

The following paragraphs (M1) through (M10) describe examples of methods that may be implemented in accordance with the present disclosure.

(M1) A method comprising receiving, by a computing device, a data sharing rule, wherein the data sharing rule indicates a group of applications that are authorized to share data; receiving, by the computing device and for a first application, an encrypted file; receiving, by the computing device and from a second application, a first request to access content of the encrypted file; decrypting, by the computing device and based on the first application and the second application being included in the group of applications, the encrypted file for the second application; receiving, by the computing device and from a third application, a second request to access the content of the encrypted file; and rejecting, by the computing device and based on the third application not being included in the group of applications, the second request to access the content of the encrypted file.

(M2) A method may be performed as described in paragraph (M1) wherein the data sharing rule is based on a user identifier of a user of the computing device, a device identifier of the computing device, or a store identifier of an application store providing the first application.

(M3) A method may be performed as described in any of paragraphs (M1) through (M2) wherein receiving the encrypted file may comprise: downloading, by the first application, a non-encrypted file; receiving an application key associated with the first application; generating a content key associated with the encrypted file; generating the encrypted file by encrypting the non-encrypted file with the content key; generating metadata for the encrypted file based on one or more of: a user identifier of a user of the computing device, a device identifier of the computing device, a store identifier of an application store, an application identifier for the first application, or the content key; encrypting the metadata with the application key; and adding the encrypted metadata to the encrypted file.

(M4) A method may be performed as described in any of paragraphs (M1) through (M3) wherein decrypting the encrypted file for the second application further comprises decrypting the encrypted metadata with the application key; retrieving the content key; and decrypting the encrypted file with the content key.

(M5) A method may be performed as described in any of paragraphs (M1) through (M4) wherein applications in the group of applications share a clipboard, and the method further comprises allowing each application, in the group of applications, access to content in the clipboard; and denying another application, not included in the group of applications, access to the content in the clipboard.

(M6) A method may be performed as described in any of paragraphs (M1) through (M5), further comprising maintaining a shared group folder, in the computing device, for storing files downloaded by applications in the group of applications; allowing each application, in the group of applications, access to the stored files in the shared group folder; and denying another application, not included in the group of applications, access to the stored files in the shared group folder.

(M7) A method may be performed as described in any of paragraphs (M1) through (M6) wherein decrypting the encrypted file for the second application comprises: sending, to a key management server, information comprising one or more of: a user identifier of a user accessing the encrypted file, a device identifier of the computing device, an application identifier of the first application, a file location of the encrypted file in the computing device; or a store identifier for an application store providing the first application; receiving, from the key management server, a key; and decrypting at least a portion of the encrypted file with the key.

(M8) A method may be performed as described in paragraph (M7) wherein sending the information is based on a determination that the key is not stored in a cache of the computing device.

(M9) A method may be performed as described in any of paragraphs (M1) through (M8) wherein decrypting the encrypted file for the second application comprises decrypting at least a portion of the encrypted file with a key associated with the first application.

The following paragraphs (A1) through (A10) describe examples of apparatuses that may be implemented in accordance with the present disclosure.

(A1) An apparatus comprising one or more processors and memory storing instructions that, when executed by the one or more processors, cause the apparatus to receive a data sharing rule, wherein the data sharing rule indicates a group of applications that are authorized to share data; receive, for a first application, an encrypted file; receive, from a second application, a first request to access content of the encrypted file; decrypt, based on the first application and the second application being included in the group of applications, the encrypted file for the second application; receive, from a third application, a second request to access the content of the encrypted file; and reject, based on the third application not being included in the group of applications, the second request to access the content of the encrypted file.

(A2) The apparatus as described in paragraph (A1), wherein the instructions, when executed by the one or more processors, further cause the apparatus to receive the encrypted file by: downloading, by the first application, a non-encrypted file; receiving an application key associated with the first application; generating a content key associated with the encrypted file; generating the encrypted file by encrypting the non-encrypted file with the content key; generating metadata for the encrypted file based on one or more of: a user identifier of a user of the apparatus, a device identifier of the apparatus, a store identifier of an application store, an application identifier for the first application, or the content key; encrypting the metadata with the application key; and adding the encrypted metadata to the encrypted file.

(A3) The apparatus as described in any of paragraphs (A1) through (A2), wherein the instructions, when executed by the one or more processors, further cause the apparatus to decrypt the encrypted file for the second application further by: decrypting the encrypted metadata with the application key to retrieve the content key; and decrypting the encrypted file with the content key.

(A4) The apparatus as described in any of paragraphs (A1) through (A3), wherein the instructions, when executed by the one or more processors, further cause the apparatus to decrypt the encrypted file for the second application by: sending, to a key management server, information comprising one or more of: a user identifier of a user accessing the encrypted file, a device identifier of the apparatus, an application identifier of the first application, a file location of the encrypted file in the apparatus, or a store identifier for an application store providing the first application; receiving, from the key management server, a key; and decrypting at least a portion of the encrypted file with the key.

(A5) The apparatus as described in any of paragraphs (A1) through (A4), wherein the instructions, when executed by the one or more processors, further cause the apparatus to send the information based on a determination that the key is not stored in a cache of the apparatus.

(A6) The apparatus as described in any of paragraphs (A1) through (A5), wherein the instructions, when executed by the one or more processors, further cause the apparatus to decrypt the encrypted file for the second application by decrypting at least a portion of the encrypted file with a key associated with the first application.

The following paragraphs (CRM1) through (CRM10) describe examples of computer-readable media that may be implemented in accordance with the present disclosure.

(CRM1) A non-transitory computer-readable medium storing instructions that, when executed, cause a system to perform: receiving a data sharing rule, wherein the data sharing rule indicates a group of applications that are authorized to share data; receiving, for a first application, an encrypted file; receiving, from a second application, a first request to access content of the encrypted file; decrypting, based on the first application and the second application being included in the group of applications, the encrypted file for the second application; receiving, from a third application, a second request to access the content of the encrypted file; and rejecting, based on the third application not being included in the group of applications, the second request to access the content of the encrypted file.

(CRM2) A non-transitory computer-readable medium as described in paragraph (CRM1) wherein the instructions, when executed, further cause receiving the encrypted file by: downloading, by the first application, a non-encrypted file; receiving an application key associated with the first application; generating a content key associated with the encrypted file; generating the encrypted file by encrypting the non-encrypted file with the content key; generating metadata for the encrypted file based on one or more of: a user identifier of a user, a device identifier, a store identifier of an application store, an application identifier for the first application, or the content key; encrypting the metadata with the application key; and adding the encrypted metadata to the encrypted file.

(CRM3) A non-transitory computer-readable medium as described in any of paragraphs (CRM1) through (CRM2), wherein the instructions, when executed, further cause decrypting the encrypted file for the second application further by: decrypting the encrypted metadata with the application key to retrieve the content key; and decrypting the encrypted file with the content key.

(CRM4) A non-transitory computer-readable medium as described in any of paragraphs (CRM1) through (CRM3), wherein the instructions, when executed, further cause decrypting the encrypted file for the second application by: sending, to a key management server, information comprising one or more of: a user identifier of a user accessing the encrypted file, a device identifier, an application identifier of the first application, a file location of the encrypted file, or a store identifier for an application store providing the first application; receiving, from the key management server, a key; and decrypting at least a portion of the encrypted file with the key.

(CRM5) A non-transitory computer-readable medium as described in any of paragraphs (CRM1) through (CRM4), wherein the instructions, when executed, further cause sending the information based on a determination that the key is not stored in a cache.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a computing device, a data sharing rule, wherein the data sharing rule indicates a group of applications that are authorized to share data;
receiving, by the computing device, a file associated with a first application;
receiving, by the computing device and from a second application, a first request to access content of the file;
allowing, by the computing device, the second application to access the file if the the second application is included in the group of applications that are authorized to share the data; and
preventing, by the computing device, the second application from access to the file if the second application is not included in the group of applications that are authorized to share the data.

2. The method of claim 1, further comprising:
receiving, by the computing device and from a third application, a second request to access content of the file; and
rejecting, by the computing device and based on the third application not being included in the group of applications that are authorized to share the data, the second request to access the content of the file.

3. The method of claim 1, wherein the file is an encrypted file; and
wherein allowing the second application to access the file comprises decrypting the file for the second application.

4. The method of claim 1, wherein the data sharing rule is based on:
a user identifier of a user of the computing device;
a device identifier of the computing device; or
a store identifier of an application store providing the first application.

5. The method of claim 1, wherein receiving the file comprises:
downloading, by the first application, a non-encrypted file;
receiving an application key associated with the first application;
generating a content key;
generating an encrypted file by encrypting the non-encrypted file with the content key;
generating metadata for the encrypted file based on one or more of:
a user identifier of a user of the computing device;
a device identifier of the computing device;
a store identifier of an application store;
an application identifier for the first application; or
the content key;
encrypting the metadata with the application key; and
adding the encrypted metadata to the encrypted file.

6. The method of claim 5, wherein allowing the second application to access the file comprises decrypting the encrypted file for the second application by:
decrypting the encrypted metadata with the application key;
retrieving the content key; and
decrypting the encrypted file with the content key.

7. The method of claim 1, wherein applications in the group of applications share a clipboard, the method further comprising:
allowing each application, in the group of applications, access to content in the clipboard; and
denying another application, not included in the group of applications, access to the content in the clipboard.

8. The method of claim 1, wherein allowing the second application to access the file comprises:
sending, to a key management server, information comprising one or more of:
a user identifier of a user accessing the file;
a device identifier of the computing device;
an application identifier of the first application;
a file location of the file in the computing device; or
a store identifier for an application store providing the first application;
receiving, from the key management server, a key; and
decrypting at least a portion of the file with the key.

9. The method of claim 8, wherein sending the information is based on a determination that the key is not stored in a cache of the computing device.

10. The method of claim 1, wherein allowing the second application to access the file comprises decrypting at least a portion of the file with an application key associated with the first application.

11. An apparatus comprising:
one or more processors; and
memory storing instructions that, when executed by the one or more processors, cause the apparatus to:
receive a data sharing rule, wherein the data sharing rule indicates a group of applications that are authorized to share data;
receive a file associated with a first application;
receive, from a second application, a first request to access content of the file;
allow the second application to access the file if the the second application is included in the group of applications that are authorized to share the data; and
prevent the second application from access to the file if the second application is not included in the group of applications that are authorized to share the data.

12. The apparatus of claim 11, wherein the file is an encrypted file; and
wherein the instructions, when executed by the one or more processors, further cause the apparatus to allow the second application to access the file by decrypting the file for the second application.

13. The apparatus of claim 11, wherein applications in the group of applications share a clipboard; and
wherein the instructions, when executed by the one or more processors, further cause the apparatus to:
allow each application, in the group of applications, access to content in the clipboard; and
deny another application, not included in the group of applications, access to the content in the clipboard.

14. The apparatus of claim 11, wherein the instructions, when executed by the one or more processors, further cause the apparatus to receive the file by:
downloading, by the first application, a non-encrypted file;
receiving an application key associated with the first application;
generating a content key;
generating an encrypted file by encrypting the non-encrypted file with the content key;
generating metadata for the encrypted file based on one or more of:
a user identifier of a user of the apparatus;
a device identifier of the apparatus;
a store identifier of an application store;
an application identifier for the first application; or
the content key;
encrypting the metadata with the application key; and
adding the encrypted metadata to the encrypted file.

15. The apparatus of claim 14, wherein the instructions, when executed by the one or more processors, further cause the apparatus to allow the second application to access the file by:
decrypting the encrypted metadata with the application key;
retrieving the content key; and
decrypting the encrypted file with the content key.

16. The apparatus of claim 11, wherein the instructions, when executed by the one or more processors, further cause the apparatus to allow the second application to access the file by decrypting at least a portion of the file with an application key associated with the first application.

17. A non-transitory computer-readable medium storing instructions that, when executed, cause:
receiving a data sharing rule, wherein the data sharing rule indicates a group of applications that are authorized to share data;
receiving a file associated with a first application;
receiving, from a second application, a first request to access content of the file;
allowing the second application to access the file if the the second application is included in the group of applications that are authorized to share the data; and
preventing the second application from access to the file if the second application is not included in the group of applications that are authorized to share the data.

18. The non-transitory computer-readable medium of claim 17, wherein the file is an encrypted file; and
wherein the instructions, when executed, further cause allowing the second application to access the file by decrypting the file for the second application.

19. The non-transitory computer-readable medium of claim 17, wherein applications in the group of applications share a clipboard; and
wherein the instructions, when executed, further cause:
allowing each application, in the group of applications, access to content in the clipboard; and
denying another application, not included in the group of applications, access to the content in the clipboard.

20. The non-transitory computer-readable medium of claim 17, wherein the instructions, when executed, further cause allowing the second application to access the file by decrypting at least a portion of the file with an application key associated with the first application.
